(19) United States
(12) Patent Application Publication
(10) Pub. No.: US 2024/0276469 A1
(43) Pub. Date: Aug. 15, 2024

(54) Dynamic Frequency Selection Detection Using a Group of Access Points

(71) Applicant: ARRIS Enterprises LLC, Suwanee, GA (US)

(72) Inventors: Gopakumar Thathramveedu, Cupertino, CA (US); Genyuan Wang, Santa Clara, CA (US); Virendra Malaviya, Cupertino, CA (US)

(73) Assignee: ARRIS Enterprises LLC, Suwanee, GA (US)

(21) Appl. No.: 18/354,692

(22) Filed: Jul. 19, 2023

Related U.S. Application Data
(60) Provisional application No. 63/368,983, filed on Jul. 21, 2022.

(51) Int. Cl. H04W 72/0453; H04W 72/566

(52) U.S. Cl. CPC H04W 72/0453; H04W 72/566

(57) ABSTRACT

During operation, an electronic device may detect wireless signals associated with a potential higher priority user in a band of frequencies subject to a dynamic frequency selection (DFS) regulation. Then, the electronic devices may receive, associated with remaining electronic devices in a group of electronic devices that includes the electronic device, information specifying whether the remaining electronic devices detected the wireless signals or additional wireless signals associated with the potential higher priority user in the band of frequencies. Moreover, the electronic device may determine whether the detected wireless signals are a true positive detection or a false positive detection based at least in part on the information and a detection threshold. When the electronic device determines that the detected wireless signals are the true positive detection, the electronic device may selectively perform the DFS by ceasing use of at least a portion of the band of frequencies.

### CROSS REFERENCE TO RELATED APPLICATIONS

This application claims priority under 35 U.S.C. 119(e) to U.S. Provisional Application Ser. No. 63/368,983, “Dynamic Frequency Selection Detection Using a Group of Access Points,” filed on Jul. 21, 2022, by Gopakumar Thathramveedu et al., the contents of which are herein incorporated by reference.

### FIELD

The described embodiments relate to techniques for communication. Notably, the described embodiments relate to techniques for dynamically detecting when dynamic frequency selection (DFS) needs to be performed using a group of access points.

### BACKGROUND

Many electronic devices are capable of wirelessly communicating with other electronic devices. For example, these electronic devices can include a networking subsystem that implements a network interface for a wireless local area network (WLAN), e.g., a wireless network such as described in the Institute of Electrical and Electronics Engineers (IEEE) 802.11 standard (which is sometimes referred to as ‘Wi-Fi’). For example, a wireless network may include an access point that communicates wirelessly with one or more associated electronic devices (which are sometimes referred to as ‘clients’).

However, the performance during wireless communication between electronic devices can vary significantly over time. For example, many WLANs are allowed to use a restricted band of frequencies (such as a portion of the 5 GHz band of frequencies) that, in principle, are dual use. In an alternate restricted use case, a restricted band of frequencies may be used by the government for military purposes or for weather forecasting. Consequently, electronic devices that use restricted band of frequencies are typically required to scan for wireless signals associated with a higher priority user in the alternate restricted use case, such as radar signals. If an electronic device detects such wireless signals (e.g., in a channel in the restricted band of frequencies), the electronic device is usually required to quickly cease using the channel in the restricted band of frequencies (which is sometimes referred to as ‘dynamic frequency selection’ or DFS).

In practice, it is typically difficult for electronic devices to accurately detect wireless signals associated with a higher priority user. Consequently, there are often false positive detections, which cause electronic devices to unnecessarily cease using the restricted band of frequencies. Moreover, when the electronic device ceases using at least a portion of the restricted band of frequencies, the electronic device may transfer communication to a more crowded another channel in the restricted band of frequencies or another band of frequencies where communication is slower. Consequently, the false positive detections usually adversely impact communication performance and, thus, degrade the user experience

### SUMMARY

In a first group of embodiments, an electronic device that selectively performs DFS is described. This electronic device includes an interface circuit that communicates with a computer system and remaining electronic devices in a group of electronic devices that includes the electronic device. During operation, the electronic device detects wireless signals associated with a potential higher priority user in a band of frequencies subject to a DFS regulation. Then, the electronic device receives, associated with the remaining electronic devices, information specifying whether the remaining electronic devices detected the wireless signals or additional wireless signals associated with the potential higher priority user in the band of frequencies. Moreover, the electronic device determines whether the detected wireless signals are a true positive detection or a false positive detection based at least in part on the information and a detection threshold. When the electronic device determines that the detected wireless signals are the true positive detection, the electronic device selectively performs the DFS by ceasing use of at least a portion of the band of frequencies (such as an affected channel). Furthermore, the electronic device provides, addressed to the computer system or the remaining electronic devices, a notification as to whether the detected wireless signals are the true positive detection or the false positive detection.

Note that the electronic device may be an access point. Moreover, the remaining electronic devices may be access points.

Furthermore, the electronic device may receive, associated with the computer system the detection threshold.

Additionally, the computer system may include a controller of the electronic device or a cloud-based analytics service.

In some embodiments, the determining whether the detected wireless signals are the true positive detection or the false positive detection may be based at least in part on a number of the remaining electronic devices that detected the wireless signals or additional wireless signals. For example, the detection threshold may be an integer number greater than one.

Note that at least one of the remaining electronic devices may be outside of wireless range of the electronic device. Moreover, at least one of the remaining electronic devices may be M hops away from the electronic device, where M is an integer greater than one.

Furthermore, the remaining electronic devices may include at least a second electronic device.

Additionally, the determining whether the detected wireless signals are the true positive detection or the false positive detection may be based at least in part on spatial and temporal statistical associations of detections of the wireless signals or the additional wireless signals among the remaining electronic devices. In some embodiments, the determining whether the detected wireless signals are the true positive detection or the false positive detection may be based at least in part on a history of false positive detections for the remaining electronic devices.

In some embodiments, the electronic device and the remaining electronic devices may be aggregated into the group of electronic devices based at least in part on: signal-to-noise ratios, received signal strength indicators, and/or another communication-performance metric. Note that the aggregation may be performed by the computer system. Thus, the electronic device may receive, associated with the computer system, second information specifying the remaining electronic devices.

Moreover, the band of frequencies may include a 5 GHz band of frequencies.

Another embodiment provides the interface circuit.

Another embodiment provides one of the remaining electronic devices.

Another embodiment provides the computer system.

Another embodiment provides a computer-readable storage medium with program instructions for use with the electronic device. When executed by the electronic device, the program instructions cause the electronic device to perform at least some of the aforementioned operations in one or more of the preceding embodiments.

Another embodiment provides a method, which may be performed by the electronic device. This method includes at least some of the aforementioned operations in one or more of the preceding embodiments.

In a second group of embodiments, an electronic device that selectively performs DFS is described. This electronic device includes an interface circuit that communicates with a computer system. During operation, the electronic device detects wireless signals associated with a potential higher priority user in a band of frequencies subject to a DFS regulation. Then, the electronic devices provides, addressed to the computer system, information indicating that the electronic device detected the wireless signals associated with the potential higher priority user in the band of frequencies. Next, the electronic device receives, associated with the computer system, a notification as to whether the detected wireless signals are a true positive detection or a false positive detection. When the detected wireless signals are the true positive detection, the electronic device selectively performs the DFS by ceasing use of at least a portion of the band of frequencies.

Note that the electronic device may be an access point.

Moreover, the computer system may include a controller of the electronic device or a cloud-based analytics service.

Furthermore, the band of frequencies may include a 5 GHz band of frequencies.

Another embodiment provides the interface circuit.

Another embodiment provides the computer system. The computer system may receive, from a group of electronic devices that includes the electronic device, notifications as to whether the group of electronic devices detected the wireless signals or additional wireless signals associated with the potential higher priority user in the band of frequencies. Then, the computer system may determine whether the detected wireless signals and/or the additional wireless signals are the true positive detection or the false positive detection based at least in part on a detection threshold. When the computer system determines that the detected wireless signals and/or the additional wireless signals are the true positive detection, the computer system provides, addressed to electronic devices in the group of electronic devices, a notification that the detected wireless signals and/or the additional wireless signals are the true positive detection.

Note that the remaining electronic devices may be access points.

Moreover, the determining whether the detected wireless signals and/or the additional wireless signals are the true positive detection or the false positive detection may be based at least in part on a number of electronic devices in the group of electronic devices that detected the wireless signals and/or the additional wireless signals. For example, the detection threshold may be an integer number greater than one.

Furthermore, at least two electronic devices in the group of electronic devices may be outside of wireless range of each other. For example, at least two of the electronic devices may be M hops away from each other, where M is an integer greater than one.

Additionally, the group of electronic devices may include at least two electronic devices.

In some embodiments, the determining whether the detected wireless signals and/or the additional wireless signals are the true positive detection or the false positive detection may be based at least in part on spatial and temporal statistical associations of detections of the wireless signals and/or the additional wireless signals among the group of electronic devices. Moreover, the determining whether the detected wireless signals and/or the additional wireless signals are the true positive detection or the false positive detection may be based at least in part on a history of false positive detections for the group of electronic devices.

Furthermore, the group of electronic devices may be aggregated based at least in part on: signal-to-noise ratios, received signal strength indicators, and/or another communication-performance metric. Note that the aggregation may be performed by the computer system. Thus, the computer system may provide, addressed to electronic devices in the group of electronic devices, information specifying the electronic devices in the group of electronic devices.

Another embodiment provides a computer-readable storage medium with program instructions for use with the electronic device. When executed by the electronic device, the program instructions cause the electronic device to perform at least some of the aforementioned operations in one or more of the preceding embodiments.

Another embodiment provides a method, which may be performed by the electronic device. This method includes at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for selectively performing dynamic frequency selection (DFS) in accordance with an embodiment of the present disclosure.

FIG. 3 is a drawing illustrating an example of communication among the electronic devices in FIG. 1 in accordance with an embodiment of the present disclosure.

FIG. 4 is a flow diagram illustrating an example of detection of wireless signals in a band of frequencies by a group of electronic devices in accordance with an embodiment of the present disclosure.

FIG. 5 is a flow diagram illustrating an example of a method for determining whether detected wireless signals are a true positive detection or a false positive detection in accordance with an embodiment of the present disclosure.

FIG. 6 is a drawing illustrating an example of communication among the electronic devices in FIG. 1 in accordance with an embodiment of the present disclosure.

FIG. 7 is a flow diagram illustrating an example of detection of wireless signals in a band of frequencies by a computer system using information from a group of electronic devices in accordance with an embodiment of the present disclosure.

FIG. 8 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, an electronic device (such as an access point) that selectively performs DFS is described. This electronic device includes an interface circuit that communicates with a computer system (such as a controller or a cloud-based analytics service) and remaining electronic devices in a group of electronic devices that includes the electronic device. During operation, the electronic device may detect wireless signals associated with a potential higher priority user in a band of frequencies subject to a DFS regulation. Then, the electronic devices may receive, associated with the remaining electronic devices, information specifying whether the remaining electronic devices detected the wireless signals or additional wireless signals associated with the potential higher priority user in the band of frequencies. Moreover, the electronic device may determine whether the detected wireless signals are a true positive detection or a false positive detection based at least in part on the information and a detection threshold. When the electronic device determines that the detected wireless signals are the true positive detection, the electronic device may selectively perform the DFS by ceasing use of at least a portion of the band of frequencies. Furthermore, the electronic device may provide, addressed to the computer system or the remaining electronic devices, a notification as to whether the detected wireless signals are the true positive detection or the false positive detection.

In a second group of embodiments, an electronic device (such as an access point) that selectively performs a DFS is described. This electronic device includes an interface circuit that communicates with a computer system (such as a controller or a cloud-based analytics service). During operation, the electronic device may detect wireless signals associated with a potential higher priority user in a band of frequencies subject to a DFS regulation. Then, the electronic devices may provide, addressed to the computer system, information indicating that the electronic device detected the wireless signals associated with the potential higher priority user in the band of frequencies. Next, the electronic device may receive, associated with the computer system, a notification as to whether the detected wireless signals are a true positive detection or a false positive detection. When the detected wireless signals are the true positive detection, the electronic device may selectively perform the DFS by ceasing use of at least a portion of the band of frequencies.

Consequently, the communication techniques may be performed in a distributed manner by the electronic devices in the group of electronic devices, in a centralized manner by the computer system, or jointly by the group of electronic devices and the computer system.

By using information from multiple electronic devices in the group of electronic devices to determine whether or not the detected wireless signals are the true positive detection or the false positive detection (and, thus, whether or not the potential higher priority user is actually a higher priority user), these communication techniques may reduce incidences of false positive detections. Consequently, the communication techniques may help ensure that the electronic device is more likely to or only performs the DFS and, thus, cease to use of at least a portion of the band of frequencies, when it is necessary. This capability may increase the likelihood or ensure that the electronic device transfers communication to a more crowded band of frequencies where communication is slower when needed. Therefore, the communication techniques may help improve the communication performance of the electronic device and, thus, may improve the user experience when using or communicating with the electronic device.

In the discussion that follows, electronic devices or components in a system (such as an access point, a router, a gateway or a network gateway, a radio node, e.g., an eNodeB, or another type of computer network device) communicate frames or packets in accordance with one or more wireless communication protocol, such as an IEEE 802.11 standard (which is sometimes referred to as ‘Wi-Fi,’ from the Wi-Fi Alliance of Austin, Texas), Bluetooth (from the Bluetooth Special Interest Group of Kirkland, Washington), BLE (from the Bluetooth Special Interest Group of Kirkland, Washington), an IEEE 802.15.4 standard (which is sometimes referred to as Zigbee), Z-Wave (from Sigma Designs, Inc. of Fremont, California), LoRaWAN (from the Lora Alliance of Beaverton, Oregon), Thread (from the Thread Group of San Ramon, California), IPv6 over low-power wireless personal area networks or 6LoWPAN (from the Internet Engineering Taskforce of Fremont, California) a cellular-telephone network or data network communication protocol (such as a third generation or 3G communication protocol, a fourth generation or 4G communication protocol, e.g., Long Term Evolution or LTE or 5GC (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

Moreover, an access point, a radio node, a base station or a switch in the wireless network and/or the cellular-telephone network may communicate with a local or remotely located computer system (such as a controller) using a wired communication protocol, such as a wired communication protocol that is compatible with an IEEE 802.3 standard (which is sometimes referred to as ‘Ethernet’), e.g., an Ethernet II standard, Message Queueing Telemetry Transport (MQTT) and/or another type of wired interface. However, a wide variety of communication protocols may be used in the system, including wired and/or wireless communication. In the discussion that follows, Wi-Fi and Ethernet are used as illustrative examples.

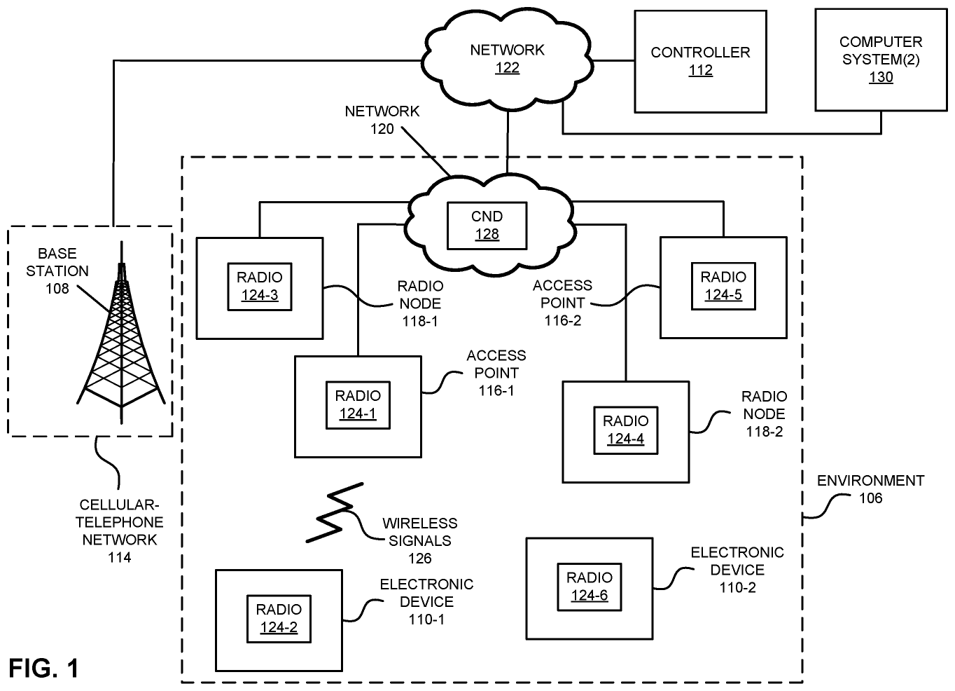

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc.) via a macrocell in a cellular-telephone network 114 (which may include a base station 108), one or more access points 116 (which may communicate using Wi-Fi) in a WLAN and/or one or more radio nodes 118 (which may communicate using LTE) in another cellular-telephone network (such as a small-scale network or a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘computer network device.’ Moreover, one or more base stations (such as base station 108), access points 116, and/or radio nodes 118 may be included in one or more wireless networks, such as: a WLAN and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or optional controller 112 (which may be a local or a cloud-based controller that manages and/or configures access points 116, radio nodes 118 and/or a computer network device (CND) 128) using a wired communication protocol (such as Ethernet) via network 120 and/or 122. Alternatively, or additionally, access points 116 and/or radio nodes 118 may communicate with optional computer system 130 (which may provide cloud-based storage and/or analytics services, and thus which may include one or more computers at one or more locations) using the wired communication protocol. However, in some embodiments, access points 116 and/or radio nodes 118 may communicate with each other, controller 112 and/or computer system 130 using wireless communication (e.g., one of access points 116 may be a mesh access point in a mesh network). Note that networks 120 and 122 may be the same or different networks. For example, networks 120 and/or 122 may include an LAN, a mesh network, point-to-point connections, an intra-net or the Internet. In some embodiments, network 120 may include one or more routers and/or switches (such as computer network device 128).

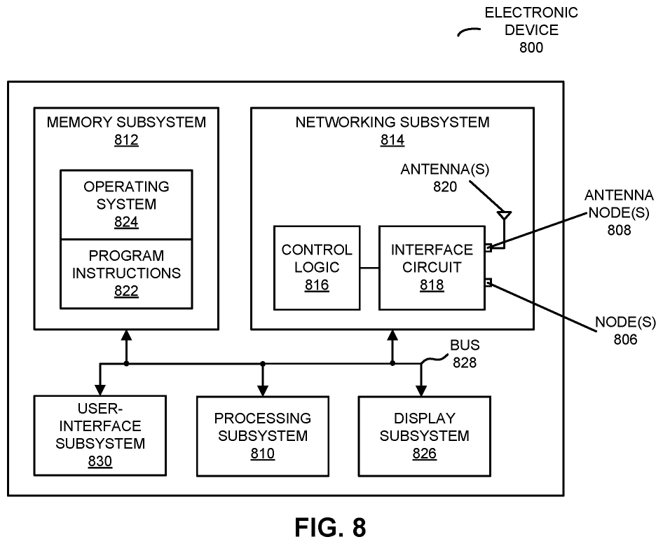

As described further below with reference to FIG. 8, electronic devices 110, controller 112, access points 116, radio nodes 118, computer network device 128, and/or computer system 130 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc. Note that while instances of radios 124 are shown in electronic devices 110, access points 116 and radio nodes 118, one or more of these instances may be different from the other instances of radios 124.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads). In some embodiments, the wireless communication, e.g., by access points 116, may involve the use of dedicated connections, such as via a peer-to-peer (P2P) communication techniques.

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames. Moreover, access point 116-1 may allow electronic device 110-1 to communicate with other electronic devices, computers, computer systems and/or servers via networks 120 and/or 122.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as, but not limited to: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as OFDMA) and/or MIMO communication.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

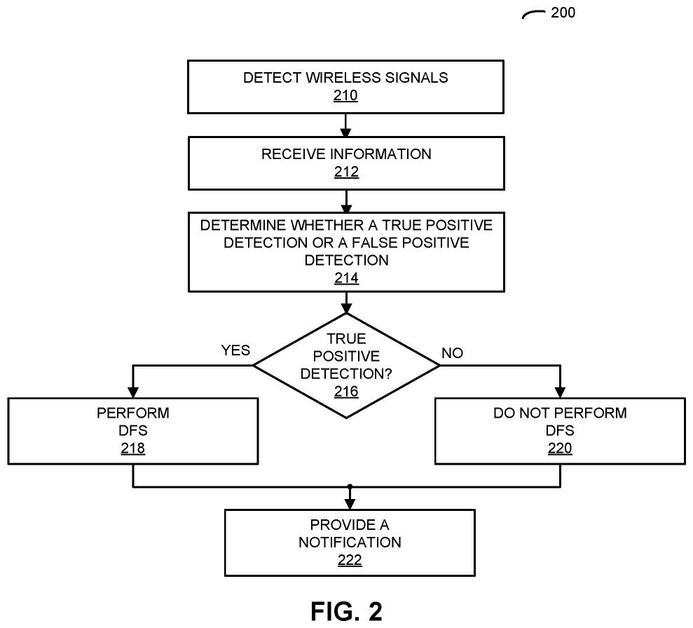

As noted previously and as described further below with reference to FIGS. 2-4, one of electronic devices 110, access points 116 or radio nodes 118 may perform at least some aspects of the communication techniques. In the discussion that follows, access point 116-1 is used as an illustrative example.

Notably, access point 116-1 may detect wireless signals associated with a potential higher priority user in a band of frequencies subject to a DFS regulation (such as the 5 GHz band of frequencies). Then, access point 116-1 may receive, from remaining electronic devices in a group of electronic devices that includes access point 116-1 (such as one or more other access points 116), information specifying whether the remaining electronic devices detected the wireless signals or additional wireless signals associated with the potential higher priority user in the band of frequencies. Moreover, access point 116-1 may determine whether the detected wireless signals are a true positive detection or a false positive detection based at least in part on the information and a detection threshold.

For example, access point 116-1 may determine whether the detected wireless signals are the true positive detection or the false positive detection based at least in part on a number of the remaining electronic devices that detected the wireless signals or additional wireless signals (such as when the number of remaining electronic devices is greater that the detection threshold). Alternatively or additionally, access point 116-1 may determine whether the detected wireless signals are the true positive detection or the false positive detection based at least in part on spatial and temporal statistical associations of detections of the wireless signals or the additional wireless signals among the remaining electronic devices. The spatial and temporal statistical associations may be based at least in part on locations of the remaining electronic devices and/or channels used by the remaining electronic devices. In some embodiments, access point 116-1 may determine whether the detected wireless signals are the true positive detection or the false positive detection based at least in part on a history of false positive detections for the remaining electronic devices (such as histories of false positive detections at particular locations). Thus, access point 116-1 may discount detection of the wireless signals or the additional wireless signals by remaining electronic devices that have histories of false positive detections.

When access point 116-1 determines that the detected wireless signals are the true positive detection, access point 116-1 may selectively perform the DFS by ceasing use of at least a portion of the band of frequencies. Furthermore, access point 116-1 may provide, addressed to computer system 130 and/or the remaining electronic devices, a notification as to whether the detected wireless signals are the true positive detection or the false positive detection.

Note that computer system 130 may provide the detection threshold to access point 116-1 (and, more generally, to the group of electronic devices).

Moreover, access point 116-1 and the remaining electronic devices may be aggregated into the group of electronic devices based at least in part on: signal-to-noise ratios, received signal strength indicators, a number clients or loading, utilization, and/or another communication-performance metric. For example, the aggregation may be performed by computer system 130. Thus, access point 116-1 may receive, from computer system 130, second information specifying the remaining electronic devices. Note that at least one of the remaining electronic devices may be outside of wireless range of access point 116-1. Moreover, at least one of the remaining electronic devices may be M hops away from access point 116-1, where M is an integer greater than one.

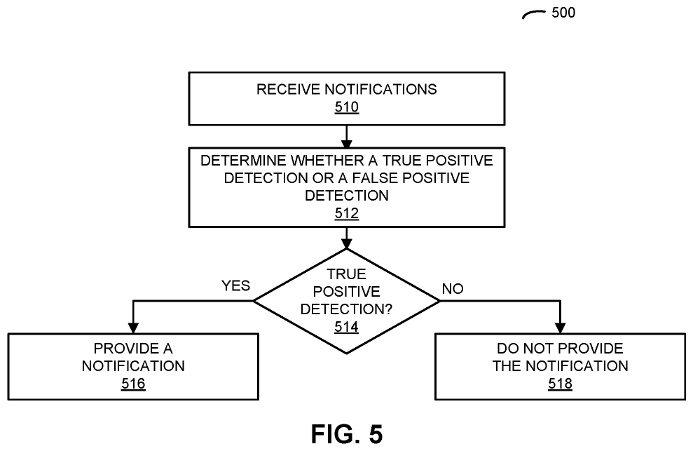

Alternatively, as described further below with reference to FIGS. 5-7, computer system 130 may perform at least some aspects of the communication techniques. Notably, access point 116-1 may detect wireless signals associated with a potential higher priority user in a band of frequencies subject to a DFS regulation (such as the 5 GHz band of frequencies). Then, access point 116-1 may provide, addressed to computer system 130, information indicating that access point 116-1 detected the wireless signals associated with the potential higher priority user in the band of frequencies.

Computer system 130 may receive, from access point 116-1, the information. In some embodiments, computer system 130 may receive, from at least some of the remaining electronic devices in the group of electronic devices that includes access point 116-1, notifications as to whether the group of electronic devices detected the wireless signals or additional wireless signals associated with the potential higher priority user in the band of frequencies. Then, computer system 130 may determine whether the detected wireless signals and/or the additional wireless signals are the true positive detection or the false positive detection based at least in part on a detection threshold.

For example, computer system 130 may determine whether the detected wireless signals and/or the additional wireless signals are the true positive detection or the false positive detection based at least in part on a number of electronic devices in the group of electronic devices that detected the wireless signals and/or additional wireless signals (such as when the number of electronic devices is greater that the detection threshold). Alternatively or additionally, computer system 130 may determine whether the detected wireless signals and/or the additional wireless signals are the true positive detection or the false positive detection based at least in part on spatial and temporal statistical associations of detections of the wireless signals and/or the additional wireless signals among the group of electronic devices. The spatial and temporal statistical associations may be based at least in part on locations of the electronic devices in the group of electronic devices and/or channels used by the electronic devices in the group of electronic devices. In some embodiments, computer system 130 may determine whether the detected wireless signals are the true positive detection or the false positive detection based at least in part on a history of false positive detections for the electronic devices in the group of electronic devices (such as histories of false positive detections at particular locations). Thus, computer system 130 may discount detection of the wireless signals and/or the additional wireless signals by electronic devices in the group of electronic devices that have histories of false positive detections.

When computer system 130 determine that the detected wireless signals and/or the additional wireless signals are the true positive detection, computer system 130 may provide, addressed to electronic devices in the group of electronic devices, a notification that the detected wireless signals and/or the additional wireless signals are the true positive detection.

Next, access point 116-1 may receive, from computer system 130, the notification as to whether the detected wireless signals are a true positive detection or a false positive detection. When the detected wireless signals are the true positive detection, access point 116-1 may selectively perform the DFS by ceasing use of at least a portion of the band of frequencies.

Note that computer system 130 may aggregate the electronic devices into the group of electronic devices based at least in part on: signal-to-noise ratios, received signal strength indicators, a number clients or loading, utilization, and/or another communication-performance metric. Thus, computer system 130 may provide, addressed to the electronic devices in the group of electronic devices, information specifying the group of electronic devices. Moreover, at least two of the electronic devices in the group of electronic devices may be outside of wireless range of each other. Furthermore, at least two of the electronic devices in the group of electronic devices may be M hops away from each other, where M is an integer greater than one.

In these ways, the communication techniques may reduce false positive detections and, thus, unnecessary performing of the DFS. Consequently, the communication techniques may ensure that electronic devices are more likely to or only cease to use of at least a portion of the band of frequencies, when it is necessary. This capability may increase the likelihood or ensure that the electronic devices transfers communication to a more crowded band of frequencies where communication is slower when needed. Therefore, the communication techniques may help improve the communication performance of the electronic devices and, thus, may improve the user experience when using or communicating with the electronic devices.

While the preceding discussion illustrated the use of the communication techniques for selective performing of DFS in a band of frequencies, in other embodiments similar operations to those in the communication techniques may be used in another frequency band (such as the CBRS) that are not subject to the DFS regulation.

We now describe embodiments of the method in the first group of embodiments. FIG. 2 presents a flow diagram illustrating an example of a method 200 for selectively performing DFS. Moreover, method 200 may be performed by an electronic device, such as one of the one or more access points 116 in FIG. 1, e.g., access point 116-1. During operation, the electronic device may detect wireless signals (operation 210) associated with a potential higher priority user in a band of frequencies subject to a DFS regulation (such as the 5 GHz band of frequencies). Then, the electronic device may receive, associated with the remaining electronic devices, information (operation 212) specifying whether the remaining electronic devices detected the wireless signals or additional wireless signals associated with the potential higher priority user in the band of frequencies.

Moreover, the electronic device may determine whether the detected wireless signals are a true positive detection or a false positive detection (operation 214) based at least in part on the information and a detection threshold. For example, the determining whether the detected wireless signals are the true positive detection or the false positive detection (operation 214) may be based at least in part on a number of the remaining electronic devices that detected the wireless signals or additional wireless signals. Notably, the detection threshold may be an integer number greater than one, and when the number of remaining electronic devices exceeds the detection threshold, the electronic device may determine that the detected wireless signals are the true positive detection. Alternatively or additionally, the determining whether the detected wireless signals are the true positive detection or the false positive detection (operation 214) may be based at least in part on spatial and temporal statistical associations of detections of the wireless signals or the additional wireless signals among the remaining electronic devices. In some embodiments, the determining whether the detected wireless signals are the true positive detection or the false positive detection (operation 214) may be based at least in part on a history of false positive detections for the remaining electronic devices. Thus, the electronic device may ignore the information from remaining electronic devices that have histories of false positive detections (such as multiple false positive detections).

When the electronic device determines that the detected wireless signals are the true positive detection (operation 216), the electronic device may selectively perform the DFS (operation 218) by ceasing use of at least a portion of the band of frequencies. Otherwise (operation 216), the electronic device may not perform the DFS (operation 220).

Furthermore, the electronic device may provide, addressed to the computer system or the remaining electronic devices, a notification (operation 222) as to whether the detected wireless signals are the true positive detection or the false positive detection. Note that the computer system may include a controller of the electronic device or a cloud-based analytics service.

In some embodiments, the electronic device optionally performs one or more additional operations. For example, the electronic device may receive, associated with the computer system the detection threshold.

Note that at least one of the remaining electronic devices may be outside of wireless range of the electronic device. Moreover, at least one of the remaining electronic devices may be M hops away from the electronic device, where M is an integer greater than one. Furthermore, the electronic device and the remaining electronic devices may be aggregated into the group of electronic devices based at least in part on: signal-to-noise ratios, received signal strength indicators, and/or another communication-performance metric. In some embodiments, the aggregation may be performed by the computer system. Thus, the electronic device may receive, associated with the computer system, second information specifying the remaining electronic devices.

In some embodiments of method 200, there may be additional or fewer operations. Moreover, the order of the operations may be changed, and/or two or more operations may be combined into a single operation.

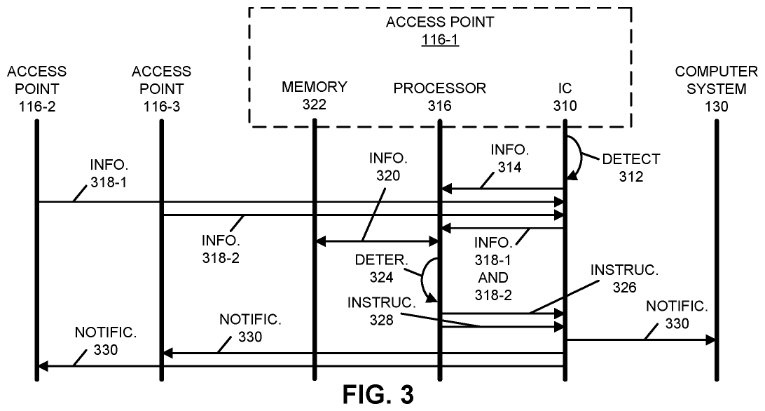

Embodiments of the communication techniques are further illustrated in FIG. 3, which presents a drawing illustrating an example of communication between access points 116 and computer system 130. Notably, interface circuit 310 in access point 116-1 may detect 312 wireless signals associated with a potential higher priority user in a band of frequencies subject to a DFS regulation. In response, interface circuit 310 may provide information 314 about detection 312 to a processor 316 in access point 116-1.

Then, interface circuit 310 may receive, associated with access points 116-2 and/or 116-3 (which may include with access point 116-1 in a group of electronic devices), information 318 specifying whether access point 116-2 and/or access point 116-3 detected the wireless signals or additional wireless signals associated with the potential higher priority user in the band of frequencies. Interface circuit 310 may provide information 318 to processor 316.

Moreover, processor 316 may determine 324 whether the detected wireless signals are a true positive detection or a false positive detection based at least in part on information 314, information 318 and a detection threshold. In some embodiments, processor 316 may perform the determining 324 using information 320 (such as histories of false positive detections for access points 116-2 and/or 116-3) stored in memory 322 in access point 116-1.

When processor 316 determines that the detected wireless signals are the true positive detection, processor 316 may selectively perform the DFS by instructing 326 interface circuit 310 to cease use of at least a portion of the band of frequencies. Furthermore, processor 316 may instruct 328 interface circuit 310 to provide, addressed to computer system 130 or access points 116-2 and 116-3, a notification 330 as to whether the detected wireless signals are the true positive detection or the false positive detection.

While FIG. 3 illustrates communication between components using unidirectional or bidirectional communication with lines having single arrows or double arrows, in general the communication in a given operation in this figure may involve unidirectional or bidirectional communication.

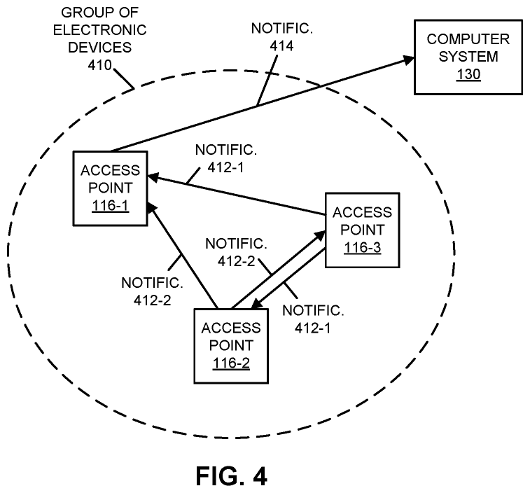

FIG. 4 presents a flow diagram illustrating an example of detection of wireless signals in a band of frequencies by a group of electronic devices. Notably, when access points 116 in a group of access points 410 detect wireless signals associated with a potential higher priority user in a band of frequencies, access points 116 may notify 412 remaining access points or electronic devices in the group of access points 410. Note that the notifications 412 may be requested or may be unsolicited. Then, a given access point (such as access point 116-1) in the group of access points 410 may use this information and any detection of the wireless signals or additional wireless signals by access point 116-1 to collectively determine whether the detection is a true positive detection or a false positive detection. When the detection is a true positive detection, access point 116-1 may perform DFS by ceasing use of at least a portion of the band of frequencies. Moreover, access point 116-1 may notify 414 computer system 130 (and/or the remaining access points) as to whether the detection was the true positive detection or the false positive detection.

We now describe embodiments of the method in the second group of embodiments. FIG. 5 presents a flow diagram illustrating an example of a method 500 for determining whether detected wireless signals are a true positive detection or a false positive detection. Moreover, method 500 may be performed by a computer system, such as computer system 130 in FIG. 1. During operation, the computer system may receive, from a group of electronic devices that includes an electronic device, notifications (operation 510) as to whether the group of electronic devices detected wireless signals and/or additional wireless signals associated with a potential higher priority user in a band of frequencies subject to DFS regulation (such as the 5 GHz band of frequencies). Note that the computer system may include a controller of the electronic device (or the group of electronic devices) or a cloud-based analytics service.

Then, the computer system may determine whether the detected wireless signals and/or the additional wireless signals are a true positive detection or a false positive detection (operation 512) based at least in part on a detection threshold. For example, the determining whether the detected wireless signals and/or the additional wireless signals are the true positive detection or the false positive detection (operation 512) may be based at least in part on a number of electronic devices in the group of electronic devices that detected the wireless signals and/or the additional wireless signals. Notably, when the number of electronic devices exceeds the detection threshold (such as an integer number greater than one), the computer system may determine that the detected wireless signals and/or the additional wireless signals are the true positive detection. Alternatively or additionally, the determining whether the detected wireless signals and/or the additional wireless signals are the true positive detection or the false positive detection (operation 512) may be based at least in part on spatial and temporal statistical associations of detections of the wireless signals and/or the additional wireless signals among the group of electronic devices. Moreover, the determining whether the detected wireless signals and/or the additional wireless signals are the true positive detection or the false positive detection (operation 512) may be based at least in part on a history of false positive detections for the group of electronic devices. Thus, the computer system may ignore the notifications from electronic devices in the group of electronic devices with histories of false positive detections (such as multiple false positive detections).

When the computer system determines that the detected wireless signals and/or the additional wireless signals are the true positive detection (operation 514), the computer system may provide, addressed to electronic devices in the group of electronic devices, a notification (operation 516) that the detected wireless signals and/or the additional wireless signals are the true positive detection. Otherwise (operation 514), the computer system may not provide the notification (operation 518).

In some embodiments, the computer system may optionally perform one or more additional operations. For example, the computer system may aggregate the electronic devices into the group of electronic devices. Thus, the computer system may provide, addressed to the electronic devices in the group of electronic devices, information specifying the group of electronic devices. Note that at least two electronic devices in the group of electronic devices may be outside of wireless range of each other. Moreover, at least two of the electronic devices may be M hops away from each other, where M is an integer greater than one. Furthermore, the group of electronic devices may be aggregated based at least in part on: signal-to-noise ratios, received signal strength indicators, and/or another communication-performance metric.

In some embodiments of method 500, there may be additional or fewer operations. Moreover, the order of the operations may be changed, and/or two or more operations may be combined into a single operation.

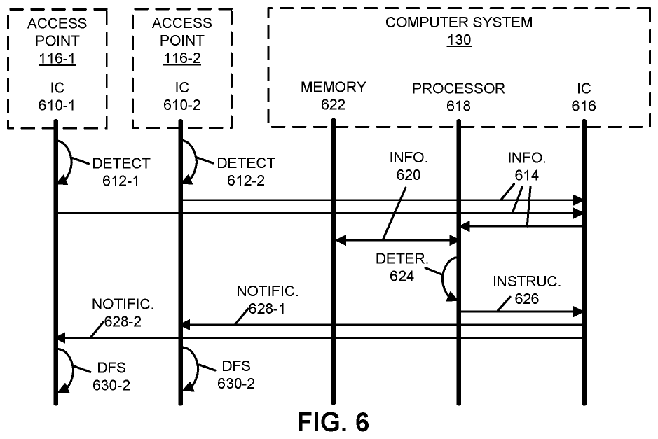

Embodiments of the communication techniques are further illustrated in FIG. 6, which presents a drawing illustrating an example of communication between access points 116-1 and 116-2 and computer system 130. Notably, one or more interface circuits 610 in one or more of access points 116 in a group of electronic devices may detect 612 wireless signals and/or additional wireless signals associated with a potential higher priority user in a band of frequencies subject to DFS regulation. Then, the one or more interface circuit 610 may provide information 614 as to whether the wireless signals and/or additional wireless signals were detected.

After receiving information 614, an interface circuit 616 in computer system 130 may provide information 614 to a processor 618 in computer system 130. Then, processor 618 may determine 624 whether the detected wireless signals and/or the additional wireless signals are a true positive detection or a false positive detection based at least in part on a detection threshold. In some embodiments, processor 618 may perform the determining 624 using information 620 (such as histories of false positive detections for access points 116) stored in memory 622 in computer system 130.

When processor 618 determines that the detected wireless signals and/or the additional wireless signals are the true positive detection, processor 618 may instruct 626 interface circuit 616 to provide, addressed to access points 116, notifications 628 that the detected wireless signals and/or the additional wireless signals are the true positive detection.

Next, after receiving notifications 628, interface circuits 610 may perform DFS 630 by ceasing use of at least a portion of the band of frequencies.

While FIG. 6 illustrates communication between components using unidirectional or bidirectional communication with lines having single arrows or double arrows, in general the communication in a given operation in this figure may involve unidirectional or bidirectional communication.

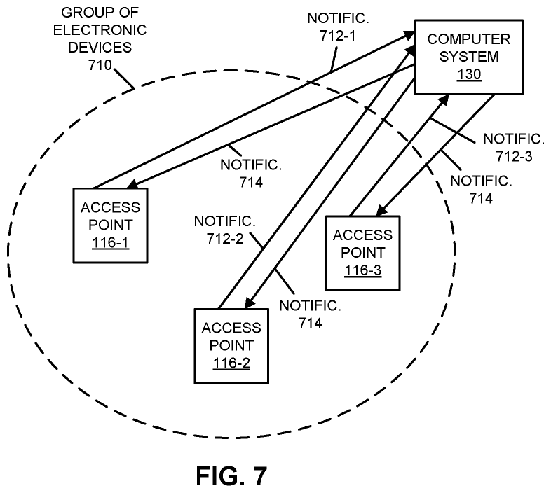

FIG. 7 presents a flow diagram illustrating an example of detection of wireless signals in a band of frequencies by a computer system using information from a group of electronic devices. Notably, when access points 116 in a group of access points 710 detect wireless signals associated with a potential higher priority user in a band of frequencies, access points 116 may notify 712 computer system 130. Then, computer system 130 may use this information to collectively determine whether the detection is a true positive detection or a false positive detection. When the detection is a true positive detection, computer system 130 may notify 714 access points 116. In response, access points 116 may perform DFS and cease use of at least a portion of the band of frequencies.

We now further describe the communication techniques. DFS refers to a set of channels in 5 GHz spectrum which an access point compatible with an IEEE 802.11 standard can use, but the incumbent radar user (which is sometimes referred to as a ‘higher priority user’) has the precedence over Wi-Fi usage. Consequently, the access point may continuously look for a radar or wireless signal during normal operation. When the access point detects a radar signal while it is currently using a DFS channel, the access point should stop using the channel within 10 secs and move to another channel. Moreover, the access point should scan for radar signals for at least 60 secs before it can use the DFS channel.

However, a radar signal may be hard to detect because it does not have a specific framing format, such as is the case for Wi-Fi wireless signals. When a false positive detection occurs, the access point can be fooled by non-radar radio-frequency or wireless signals. Sources of false positive detections may include: co-channel interference from neighboring access points; transient conditions of clients in high-density deployments; and/or radio-frequency spikes from clients because of bad drivers.

Consequently, the existing approach to radar-signal detection generates many false positive detections. Because there are no mechanisms or technique in place to determine an actual versus a false radar event, existing access points report any radar detection as a valid event and take appropriate action as deemed by the regulatory standards.

Note that avoiding false positive detections is also important because they often have a significant impact on access-point communication performance. Notably, the false positive detections may reduce channel availability. For example, when radar is detected, an access point cannot use the channel again for at least 30 min. regardless of the channel width that is configured. Thus, when the channel width is 80 or 160 MHz, the false positive detections greatly reduce the number of non-overlapping channels.

In Europe, for outdoor access points, only DFS channels can be used. In the worst-case scenario, all the channels may be blocked and an access point may end up with no channels to used. Consequently, the wireless service quality of experience (QoE) of a client may deteriorate.

Moreover, the false positive detections may result in client timeouts and disconnections. Notably, because an access point must vacate the channel in a short amount of time, the typical channel switch announcement (CSA) may not be effective or at times may not be used at all, so clients will timeout. Therefore, a client device may rescan, and reassociate, which is a long process that results in poor user experience.

Furthermore, the false positive detections may cause temporary coverage gaps. For example, a channel change prompted by a perceived radar detection may cause the access point to go to another DFS channel. The access point is required to listen for 60 seconds for a radar signal before it can begin operation, during which no clients can associate. This may particularly adversely impact the communication performance of mesh links.

As noted previously, in existing DFS approaches, when an access point detects a potential radar signal, the access point may follow DFS procedures and may send a DFS detected event to a controller or a cloud-based analytics service. Because the DFS detected event could be a false positive detection or a true positive detection, data received based on this DFS event may not be of use to a user in making further changes in channel or debug any source of transient noise.

In the disclosed communication techniques, false positive detections may be determined based at least in part on a neighboring access-point report. Notably, the communication techniques may use multi-access-point modular redundancy or N-modular redundancy. When an access point detects a radar event, it may send an inter-access-point protocol (IAP) message requesting, e.g., the three best neighbors (such as neighboring access points with the strongest received signal strengths, the largest signal-to-noise ratios, the fewest clients or the lowest loading, the lowest utilization, etc.) to report their detection of any radar signal on the DFS channel that the access point is using. If at least two of the neighbor reports indicate that radar signal is detected on the stated DFS channel, then the access point may consider the DFS event legitimate. Otherwise, the access point may consider the DFS event a false positive detection.

Note that the access point that detects a radar event may override the other access points provided that the other access points are further away from the current access point (such as being outside of wireless range of the current access point) that uses the DFS channel and that detects a radar event, which may legitimize the detection (i.e., which may indicate that it is a true positive detection). Otherwise, the access point may consider the DFS event as a false positive detection and may ignore it.

Moreover, the communication techniques may be extended to where an access point currently using DFS sends an IAP message to its neighboring access points and request them to send their neighbor reports on the DFS channel and indicate whether they detected any radar event on that DFS channel. Based at least in part on some or all of the responses within time interval, the access point can determine that the DFS event is a false positive detection when 80% or more of the access points report no radar detection.

In some embodiments of the communication techniques, the determination of true positive detections and false positive detections may, at least in part, be performed by a controller or a cloud-based analytics service. Notably, access points may be grouped into radio-frequency neighborhoods based at least in part on their proximity to each other (such as based at least in part on background scans or channel selection and adjustment techniques, or access points in a common layer-two domain). The access points may exchange information regarding DFS events (e.g., channel, time, etc.) with the controller or the cloud-based analytics service.

Then, the controller or the cloud-based analytics service may process data collected from multiple access points. When a DFS event is seen or detected by multiple access points on the same channel band and from the same radio-frequency neighborhood, it may be more likely to be real or a true positive detection.

Thus, while access points may follow DFS procedures, data can be used to provide suggestions to users and determining current or predicting future false positive detections. Consequently, the controller or the cloud-based analytics service may collect data about DFS events in a data structure, may determine, and may provide recommendation about false positive detections of radar signals.

Note that the controller or the cloud-based analytics service may be used as a planning tool, because it may have data and learning from a network about detected radar signals and recommendations provided to access points to ignore false positive detections. Therefore, in a deployment of a network near the facility where radar signals are more prevalent, the controller or the cloud-based analytics service may determine detection thresholds for each of the access points in the network to reduce/prevent false positive detections (e.g., based on site survey results after the network is deployed).

In some embodiments, instead of detecting radar signals based at least on a peak (or pulse), the access points and/or the computer system may determine whether or not detected radar signals are a true positive detection or a false positive detection based at least in part on a pattern of peaks or pulses and durations of the peaks or pulses associated with different types of radar signals.

We now describe embodiments of an electronic device, which may perform at least some of the operations in the communication techniques. FIG. 8 presents a block diagram illustrating an example of an electronic device 800 in accordance with some embodiments, such as one of: base station 108, one of electronic devices 110, controller 112, one of access points 116, one of radio nodes 118, computer network device 128, or computer system 130. This electronic device includes processing subsystem 810, memory subsystem 812, and networking subsystem 814. Processing subsystem 810 includes one or more devices configured to perform computational operations. For example, processing subsystem 810 can include one or more microprocessors, graphics processing units (GPUs), ASICs, microcontrollers, programmable-logic devices, and/or one or more digital signal processors (DSPs).

Memory subsystem 812 includes one or more devices for storing data and/or instructions for processing subsystem 810 and networking subsystem 814. For example, memory subsystem 812 can include DRAM, static random access memory (SRAM), and/or other types of memory. In some embodiments, instructions for processing subsystem 810 in memory subsystem 812 include: one or more program modules or sets of instructions (such as program instructions 822 or operating system 824, such as Linux, UNIX, Windows Server, or another customized and proprietary operating system), which may be executed by processing subsystem 810. Note that the one or more computer programs, program modules or instructions may constitute a computer-program mechanism. Moreover, instructions in the various modules in memory subsystem 812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 810.

In addition, memory subsystem 812 can include mechanisms for controlling access to the memory. In some embodiments, memory subsystem 812 includes a memory hierarchy that comprises one or more caches coupled to a memory in electronic device 800. In some of these embodiments, one or more of the caches is located in processing subsystem 810.

In some embodiments, memory subsystem 812 is coupled to one or more high-capacity mass-storage devices (not shown). For example, memory subsystem 812 can be coupled to a magnetic or optical drive, a solid-state drive, or another type of mass-storage device. In these embodiments, memory subsystem 812 can be used by electronic device 800 as fast-access storage for often-used data, while the mass-storage device is used to store less frequently used data.

Networking subsystem 814 includes one or more devices configured to couple to and communicate on a wired and/or wireless network (i.e., to perform network operations), including: control logic 816, an interface circuit 818 and one or more antennas 820 (or antenna elements). (While FIG. 8 includes one or more antennas 820, in some embodiments electronic device 800 includes one or more nodes, such as antenna nodes 808, e.g., a metal pad or a connector, which can be coupled to the one or more antennas 820, or nodes 806, which can be coupled to a wired or optical connection or link. Thus, electronic device 800 may or may not include the one or more antennas 820. Note that the one or more nodes 806 and/or antenna nodes 808 may constitute input(s) to and/or output(s) from electronic device 800.) For example, networking subsystem 814 can include a Bluetooth networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, a Zigbee networking system, a Z-Wave networking system, a LoRaWAN networking system and/or another networking system.

Note that a transmit or receive antenna pattern (or antenna radiation pattern) of electronic device 800 may be adapted or changed using pattern shapers (such as directors or reflectors) and/or one or more antennas 820 (or antenna elements), which can be independently and selectively electrically coupled to ground to steer the transmit antenna pattern in different directions. Thus, if one or more antennas 820 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 800 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 800 may use the mechanisms in networking subsystem 814 for performing simple wireless communication between the electronic devices, e.g., transmitting advertising or beacon frames and/or scanning for advertising frames transmitted by other electronic devices as described previously.

Within electronic device 800, processing subsystem 810, memory subsystem 812, and networking subsystem 814 are coupled together using bus 828. Bus 828 may include an electrical, optical, and/or electro-optical connection that the subsystems can use to communicate commands and data among one another. Although only one bus 828 is shown for clarity, different embodiments can include a different number or configuration of electrical, optical, and/or electro-optical connections among the subsystems.

In some embodiments, electronic device 800 includes a display subsystem 826 for displaying information on a display, which may include a display driver and the display, such as a liquid-crystal display, a multi-touch touchscreen, etc.

Moreover, electronic device 800 may include a user-interface subsystem 830, such as: a mouse, a keyboard, a trackpad, a stylus, a voice-recognition interface, and/or another human-machine interface. In some embodiments, user-interface subsystem 830 may include or may interact with a touch-sensitive display in display subsystem 826.

Electronic device 800 can be (or can be included in) any electronic device with at least one network interface. For example, electronic device 800 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 800, in alternative embodiments, different components and/or subsystems may be present in electronic device 800. For example, electronic device 800 may include one or more additional processing subsystems, memory subsystems, networking subsystems, and/or display subsystems. Additionally, one or more of the subsystems may not be present in electronic device 800. Moreover, in some embodiments, electronic device 800 may include one or more additional subsystems that are not shown in FIG. 8. Also, although separate subsystems are shown in FIG. 8, in some embodiments some or all of a given subsystem or component can be integrated into one or more of the other subsystems or component(s) in electronic device 800. For example, in some embodiments instructions 822 is included in operating system 824 and/or control logic 816 is included in interface circuit 818.

Moreover, the circuits and components in electronic device 800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 814 and/or of electronic device 800. The integrated circuit may include hardware and/or software mechanisms that are used for transmitting wireless signals from electronic device 800 and receiving signals at electronic device 800 from other electronic devices. Aside from the mechanisms herein described, radios are generally known in the art and hence are not described in detail. In general, networking subsystem 814 and/or the integrated circuit can include any number of radios. Note that the radios in multiple-radio embodiments function in a similar way to the described single-radio embodiments.

In some embodiments, networking subsystem 814 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 822, operating system 824 (such as a driver for interface circuit 818) or in firmware in interface circuit 818. Alternatively, or additionally, at least some of the operations in the communication techniques may be implemented in a physical layer, such as hardware in interface circuit 818.

Furthermore, the functionality of electronic device 800 may be implemented using a single electronic device or a group of electronic devices, which may be located at a single location or which may be distributed at disparate geographic locations (such as a cloud-based computing system).

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate with a computer system and remaining electronic devices in a group of electronic devices that comprises the electronic device, wherein the electronic device is configured to:
detect wireless signals associated with a potential higher priority user in a band of frequencies subject to a dynamic frequency selection (DFS) regulation;
receive, associated with the remaining electronic devices, information specifying whether the remaining electronic devices detected the wireless signals or additional wireless signals associated with the potential higher priority user in the band of frequencies;
determine whether the detected wireless signals are a true positive detection or a false positive detection based at least in part on the information and a detection threshold;
when the electronic device determines that the detected wireless signals are the true positive detection, the electronic device is configured to selectively perform the DFS by ceasing use of at least a portion of the band of frequencies; and
provide, addressed to the computer system or the remaining electronic devices, a notification as to whether the detected wireless signals are the true positive detection or the false positive detection.

2. The electronic device of claim 1, wherein the electronic device comprises an access point.

3. The electronic device of claim 1, wherein the remaining electronic devices comprise access points.

4. The electronic device of claim 1, wherein the electronic device is configured to receive, associated with the computer system the detection threshold.

5. The electronic device of claim 1, wherein the computer system comprises a controller of the electronic device or a cloud-based analytics service.

6. The electronic device of claim 1, wherein the determining whether the detected wireless signals are the true positive detection or the false positive detection is based at least in part on a number of the remaining electronic devices that detected the wireless signals or additional wireless signals.

7. The electronic device of claim 6, wherein the detection threshold comprises an integer number greater than one.

8. The electronic device of claim 1, wherein at least one of the remaining electronic devices is outside of wireless range of the electronic device.

9. The electronic device of claim 1, wherein at least one of the remaining electronic devices is M hops away from the electronic device and M is an integer greater than one.

10. The electronic device of claim 1, wherein the remaining electronic devices comprise at least a second electronic device.

11. The electronic device of claim 1, wherein the determining whether the detected wireless signals are the true positive detection or the false positive detection is based at least in part on spatial and temporal statistical associations of detections of the wireless signals or the additional wireless signals among the remaining electronic devices.

12. The electronic device of claim 1, wherein the determining whether the detected wireless signals are the true positive detection or the false positive detection is based at least in part on a history of false positive detections for the remaining electronic devices.

13. The electronic device of claim 1, wherein the electronic device and the remaining electronic devices may be aggregated into the group of electronic devices based at least in part on one or more of: signal-to-noise ratios, received signal strength indicators, or another communication-performance metric.

14. The electronic device of claim 13, wherein the electronic device is configured to receive, associated with the computer system, information specifying the group of electronic devices.

15. The electronic device of claim 1, wherein the band of frequencies comprises a 5 GHz band of frequencies.

16. A non-transitory computer-readable storage medium for use in conjunction with an electronic device, the computer-readable storage medium storing program instructions that, when executed by the electronic device, cause the electronic device to perform operations comprising:
detecting wireless signals associated with a potential higher priority user in a band of frequencies subject to a dynamic frequency selection (DFS) regulation;
receiving, associated with remaining electronic devices in a group of electronic devices that comprises the electronic device, information specifying whether the remaining electronic devices detected the wireless signals or additional wireless signals associated with the potential higher priority user in the band of frequencies;
determining whether the detected wireless signals are a true positive detection or a false positive detection based at least in part on the information and a detection threshold;
when the electronic device determines that the detected wireless signals are the true positive detection, selectively performing the DFS by ceasing use of at least a portion of the band of frequencies; and
providing, addressed to a computer system or the remaining electronic devices, a notification as to whether the detected wireless signals are the true positive detection or the false positive detection.

17. The non-transitory computer-readable storage medium of claim 16, wherein the determining whether the detected wireless signals are the true positive detection or the false positive detection is based at least in part on a number of the remaining electronic devices that detected the wireless signals or additional wireless signals.

18. A method for selectively performing dynamic frequency selection (DFS), comprising:
by an electronic device:
detecting wireless signals associated with a potential higher priority user in a band of frequencies subject to a DFS regulation;
receiving, associated with remaining electronic devices in a group of electronic devices that comprises the electronic device, information specifying whether the remaining electronic devices detected the wireless signals or additional wireless signals associated with the potential higher priority user in the band of frequencies;
determining whether the detected wireless signals are a true positive detection or a false positive detection based at least in part on the information and a detection threshold;
when the electronic device determines that the detected wireless signals are the true positive detection, selectively performing the DFS by ceasing use of at least a portion of the band of frequencies; and
providing, addressed to a computer system or the remaining electronic devices, a notification as to whether the detected wireless signals are the true positive detection or the false positive detection.

19. The method of claim 18, wherein the electronic device and the remaining electronic devices comprise access points.

20. The method of claim 18, wherein the determining whether the detected wireless signals are the true positive detection or the false positive detection is based at least in part on a number of the remaining electronic devices that detected the wireless signals or additional wireless signals.
